(19) United States
(12) Patent Application Publication
(10) Pub. No.: US 2020/0311541 A1
(43) Pub. Date: Oct. 1, 2020

(54) METRIC VALUE CALCULATION FOR CONTINUOUS LEARNING SYSTEM

(71) Applicant: International Business Machines Corporation, Armonk, NY (US)

(72) Inventors: Lukasz G. Cmielowski, Krakow (PL); Wojciech Sobala, Krakow (PL); Bartlomiej Tomasz Malecki, Slomniki (PL); Daniel Jakub Ryszka, Krakow (PL)

(21) Appl. No.: 16/367,565

(22) Filed: Mar. 28, 2019

(51) Int. Cl. G06N 3/08; G06N 3/04

(52) U.S. Cl. CPC G06N 3/08; G06N 3/04

(57) ABSTRACT

In a method for machine learning model training, the method includes one or more processors receiving a trained original machine learning model, including related parameters and a set of training data with which the machine learning model has been trained. The method further includes one or more processors determining an original quality evaluation value for the trained original machine learning model using a first set of feedback data. The method further includes one or more processors, in response to determining that the quality evaluation value is below a quality threshold value, triggering a retraining process for the original machine learning model, the retraining process comprising a first retraining phase for a first machine learning model and a second retraining phase for a second machine learning model.

### BACKGROUND OF THE INVENTION

The invention relates generally to machine learning, and more specifically, to a computer-implemented method and training system for improving a machine learning process.

Enterprises collect large amounts of data, including structured, semi-structured and unstructured data. The collected data can be analyzed using business intelligence (BI) and/or business analytics (BA) tools. Additionally, new data sources have started to also be pushed into enterprise data storage systems. The data can often come from connected sensors (i.e., Internet of Things (IoT)), which o deliver environmental data, logistic chain data, weather data, etc., to enterprise IT (information technology) centers. Because of the vast amount of data, the term “Big Data” has been coined for these types and amounts of data.

Analyzing this ever-increasing amount of data with traditional methods has become more and more infeasible. Companies have now begun analyzing the data in order to extract patterns, understand developing trends, and to classify and cluster measured data into similarity groups. Other systems may detect anomalies in data sequences (e.g., for identification of potential fraud in financial transactions or for the purpose of predictive maintenance).

There is a large range of different algorithms, denoted as machine learning algorithms that are designed to automatically analyze data, learn parameters for analysis models and visualize the results. Many of these algorithms relate to regression and classification algorithms. A special class of machine learning models is denoted as artificial neural networks (ANN). One subclass of ANNs are convolution of neural networks (CNN). Convolutional neural networks have been proven to be very efficient in image analysis, sound analysis, and natural language processing (NLP).

### SUMMARY

Aspects of the present invention disclose a method, computer program product, and system for machine learning model training. The method includes one or more processors receiving a trained original machine learning model, including related parameters and a set of training data with which the machine learning model has been trained. The method further includes one or more processors determining an original quality evaluation value for the trained original machine learning model using a first set of feedback data. The method further includes one or more processors, in response to determining that the quality evaluation value is below a quality threshold value, triggering a retraining process for the original machine learning model, the retraining process comprising a first retraining phase for a first machine learning model and a second retraining phase for a second machine learning model.

In another aspect of the invention, the first retraining phase further includes one or more processors performing a first k-fold cross-validation of the trained original machine learning model using the original set of training data and the first set of feedback data, wherein, from a first validation fold of the first k-fold cross-validation, skipping records that originate from said set of training data. In a further aspect of the invention, the first retraining phase further includes one or more processors performing a second k-fold cross-validation of said trained original machine learning model using the original set of training data, the first set of feedback data, and a second set of feedback data, wherein the second k-fold cross-validation utilizes all records from a second validation fold.

### BRIEF DESCRIPTION OF THE DRAWINGS

It should be noted that embodiments of the invention are described with reference to different subject-matters. In particular, some embodiments are described with reference to method type claims, whereas other embodiments are described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

The aspects defined above, and further aspects of the present invention, are apparent from the examples of embodiments to be described hereinafter and are explained with reference to the examples of embodiments, but to which the invention is not limited.

Various embodiments of the invention will be described, by way of example only, and with reference to the following drawings:

FIG. 1 shows a block diagram of an embodiment of the inventive computer-implemented method for improving a machine learning (ML) process, in accordance with an embodiment of the present invention.

FIG. 2 shows a block diagram of ML models, training and feedback data during a first iteration, in accordance with an embodiment of the present invention.

FIG. 3 shows a block diagram of ML models, training and feedback data during a second iteration, in accordance with an embodiment of the present invention.

FIG. 4 shows an embodiment of the training system for improving a machine learning process, in accordance with an embodiment of the present invention.

FIG. 5 shows an embodiment of a computing system comprising the ML model according to FIG. 1, in accordance with an embodiment of the present invention.

### DETAILED DESCRIPTION

In the context of this description, the following conventions, terms and/or expressions may be used:

The term ‘machine learning’ may here denote the scientific study of algorithms and statistical models that computer systems may use to progressively improve performance on a specific task. Machine learning algorithms build a mathematical model of sample data, known as “training data,” in order to make predictions or decisions without being explicitly programmed to perform the task.

The term ‘original machine learning model’ (ML model) may denote the ML model that was initially set-up and trained using an initial set of training data.

The term ‘training data’ may denote a labeled or annotated data set for use as input for the learning system (e.g., a neural network) and use the labels to check whether the learning system has recognized the input training data correctly. The labels, as well as deviations from the target value (i.e., the label), may then be used for a feedback process in order to retune the parameters (i.e., hyper-parameters) in the layers of the learning system).

The term ‘quality evaluation value’ may denote a numerical value describing the accuracy in which an ML model may identify the correct result (i.e., the labels of a labeled feedback or evaluation data set).

The term ‘feedback data’ may denote a set of data which was not part of a training data set used before to train the ML model.

The term ‘first retraining phase’ may denote a retraining phase performed after a determination that the original evaluation quality value is below a quality threshold value (i.e., if the expected accuracy of the initial trained ML model is not sufficient).

The term ‘second retraining phase’ may denote a training phase in which the used training data utilizes a different set of records and data for the training (i.e., retraining of the ML model, such as using a second set of feedback data). However, the training, in particular the selection of training records in training data folds, can occur differently if compared to the retraining to result in the first retrained ML model. The first retraining does not use the records of the first set of feedback data in order to generate the first quality evaluation value. The records of the first set of feedback data are simply skipped during the k-fold cross-validation.

The term ‘k-fold cross-validation’ may denote a technique to estimate the accuracy of an ML model. A data set may be split into k folds, k−1 folds may be used for a training of the ML model, and the last “left-over” fold is used for an accuracy test of the training. This cross-validation can be repeated for a grouping of the folds (e.g., all folds, a majority of the folds, etc.). The results from the rounds may be averaged to estimate the accuracy of the machine learning model.

In an example embodiment, K-fold cross-validation is performed as per the following steps. In a first step, partition the original training data set into k equal subsets. Each subset is called a fold, let the folds be named as f₁, f₂, . . . , fₖ. In a second step, for i=1 to i=k: (i) keep the fold f, as validation set and keep the remaining k−1 folds in the cross-validation training set; and (ii) train the machine learning (ML) model using the cross-validation training set and calculate the accuracy of the ML model by validating the predicted results against the validation set. In a third step, estimate the accuracy of the machine learning (ML) model by averaging the accuracies derived in all the k cases of cross-validation.

Thus, in the typical, traditional k-fold cross-validation method, all the entries in the original training data set are used for both, training as well as validation. Also, each entry may be used for validation once.

The term ‘partial quality evaluation values’ may denote the determined evaluation values (i.e., accuracy values) for each instance of the folds.

The term ‘multiclass classifier’ may denote an algorithm that may facilitate assigning each data point of a received input data to one of a plurality of classes.

The term ‘binary classifier’ may denote a specific form of a multiclass classifier with two classes.

The term ‘regression algorithm unit’ may denote an algorithm often used in machine learning approaches. The regression algorithm unit relates to a statistical method that enables users to summarize and study relationships between two continuous (i.e., quantitative) variables.

The term ‘neural network’ may denote connectionist systems or computing systems vaguely inspired by the biological neural networks that constitute animal and human brains. The neural network may comprise artificial neurons connected by links having a specific weight. The neurons may be organized in layers, from a large number of neurons in the input layer to a much smaller number of neurons in an output layer, with a plurality of layers between them (denoted as hidden layers). The neuron may also be denoted as nodes having an activation function. The neural network can include links from all neurons from one layer to all neurons of the next layer (i.e., fully connected neural network). The complete setting of the weights of the links and the activation functions (values) of the neurons may describe the underlying ML model.

The term ‘convolutional neural network’ may denote a special sort of a neural network in which one tries to reduce the number of required neurons from the input layer to a next layer in the neural network. A special convolution function may be used to achieve creation of a convolutional neural network.

Embodiments of the present invention recognize that the amount of data stored in enterprise IT (information technology) centers is growing faster than these data can be properly analyzed properly. The cost of storage is continuously decreasing, and the available computing power is constantly increasing.

Further embodiments of the invention recognize that, typically, in order to train machine learning models, data scientists need to build a model of the data and the underlying patterns manually, test it and repeatedly refine the model it before a machine learning model may be deployed as part of an artificial intelligence (AI) solution. However, data scientists are rare species among enterprise IT employees. As a logical consequence, IT service providers have started to offer support for enterprise AI efforts, (e.g., implementation services or training services for AI solutions).

Embodiments of the present invention also recognize a need to overcome a potential inconsistency between training approaches for artificial neural networks between a first and a second training round and subsequent training rounds. Further, due to the fact that a machine learning model is not available, a comparison to the first trained machine learning model cannot be made to make proper decisions whether to retrain a given model or not.

In the following, a detailed description of the figures will be given. All instructions in the figures are schematic. Firstly, a block diagram of an embodiment of the inventive computer-implemented method for improving a machine learning process is given. Afterwards, further embodiments, as well as embodiments of the training system for improving a machine learning process, will be described. It may be noted that the training system may also be denoted as continuous machine learning system.

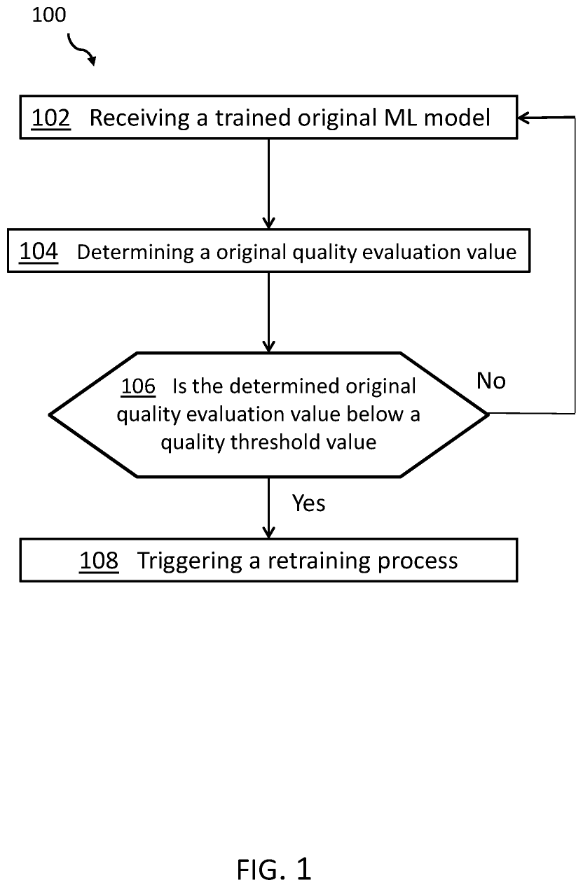

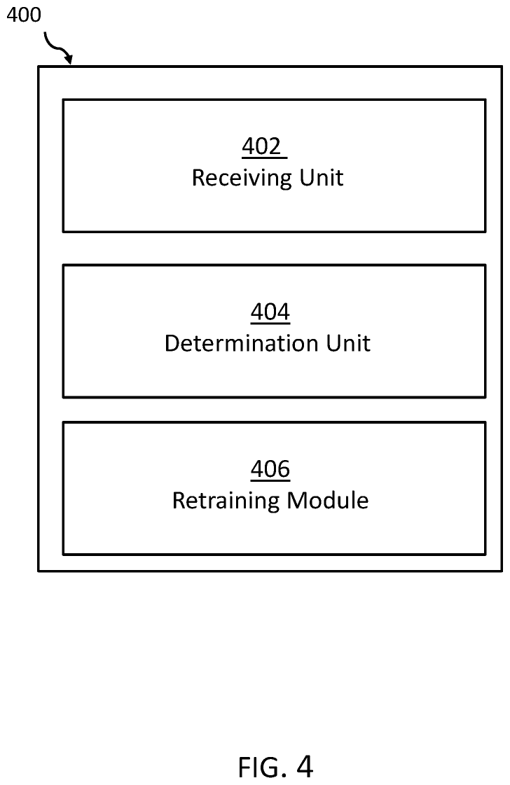

FIG. 1 shows a block diagram of an embodiment of the computer-implemented method 100 for improving a machine learning process. In various aspects of the present invention, training system 400 (discussed in further detail with regard to FIG. 4) performs the steps and processes of method 100. The method 100 comprises receiving (step 102) a trained original machine learning model (e.g., a model_0), which includes related parameters (e.g., in particular hyper-parameters describing weights and activation functions of a neural network) and a set of training data with which the machine learning model has been trained. In various embodiments, an initial model may be delivered by a customer to a machine learning service company to help the customer in the retraining phase. Thus, two different IT environments may be used for the initial and the subsequent training/retraining sessions or training phases.

The method 100 further comprises determining (in step 104) an original quality evaluation value for the trained original machine learning model using a first set of feedback data (e.g., feedback-data_1). In response to determining (in determining step Isss, “yes” branch) that the quality evaluation value is below a quality threshold value, the method further includes triggering (in step 108) a retraining process for the original machine learning model. In another embodiment, in response to determining (in determining step 106, “no” branch) that the quality evaluation value is above a quality threshold value, the method returns to step 102, to receive a trained original ML model (e.g., another model). Optionally, in response to determining (in determining step 106, “no” branch) that the quality evaluation value is above a quality threshold value, the method terminates (e.g., and initiated upon receipt of a new instance of a trained original ML model).

The retraining process (of step 108) comprises a first retraining phase resulting in a first machine learning model and a second retraining phase resulting in a second machine learning model. In various embodiments, potential subsequent retraining phases (e.g. a third, fourth, and so forth) can be treated and executed equivalently to the second retraining phase. The first retraining phase is treated and executed differently, if compared to the retraining process of the first retraining phase.

In one embodiment, the first retraining phase comprises using the original set of training data and the first set of feedback data for a first k-fold cross-validation of the trained original machine learning model. In such embodiments, the first retraining phase includes, in a first validation fold of the first k-fold cross-validation, skipping the records that originate from the set of training data.

Additional embodiments provide that not only the records of the first validation fold that have been part of the original training data are skipped. In such embodiments, the framing condition applies to all cross-validation folds.

The second retraining phase comprises using the original set of training data, the first set of feedback data (i.e., feedback-data_1) and a second (i.e., different) set of feedback data (i.e., feedback-data_2) for a second k-fold cross-validation of the trained original machine learning model. In an example embodiment, in contrast to the first retraining, from a second validation fold (which generally applied to all validation folds) of the second k-fold cross-validation all records are used (i.e., not any record is skipped).

In various embodiments, the first retraining is treated differently if compared to the second and subsequent retraining session in order to have identical comparability conditions in order to make proper decisions regarding a retraining requirement if the accuracy values of the different model resulting from the different training/retraining phases are compared.

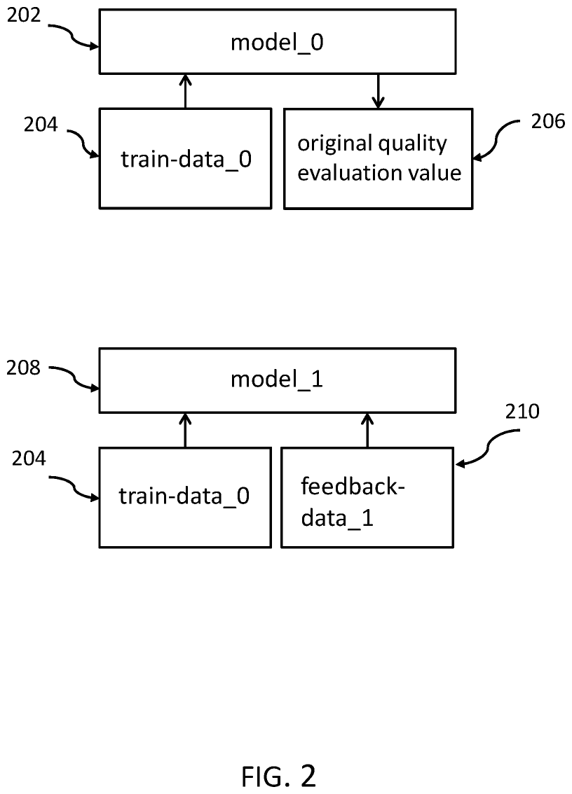

FIG. 2 illustrates the setup for the trained original machine learning (ML) model. ML model_0 202 is typically trained by users of an enterprise. In one embodiment, the users utilize the training data, in particular train-data_0 204, to derive the trained original ML model (model_0 202) and also test the model as a subset of the train-data_0 204 in order to derive the original quality evaluation value 206. Various embodiments of the present invention perform the aforementioned process using a comparison with a threshold value, in order to decide whether the ML model should undergo retraining. In a typical setup for the proposed concept, such a retraining may be performed by an experienced service provider and enough individuals working to ease the retraining efforts for the enterprise and users having set up the original model.

Another embodiment of the present invention utilizes (e.g., through training system 400) the original training data set train-data_0 204 as well as additional feedback data namely (i.e., feedback-data_1 210), in a blended version according to the cross-validation rules to develop the ML model_1 208 via a cross-validation approach. The blended or mixed data set (i.e., train-data_1) comprising the original training data (train-data_0) and the feedback-data_1 are used for the retraining resulting in the ML model 1. However, during the retraining session, the records belonging to the original training data set train-data_0 204 are not used as part of one of the k folds of the k-fold cross-validation process.

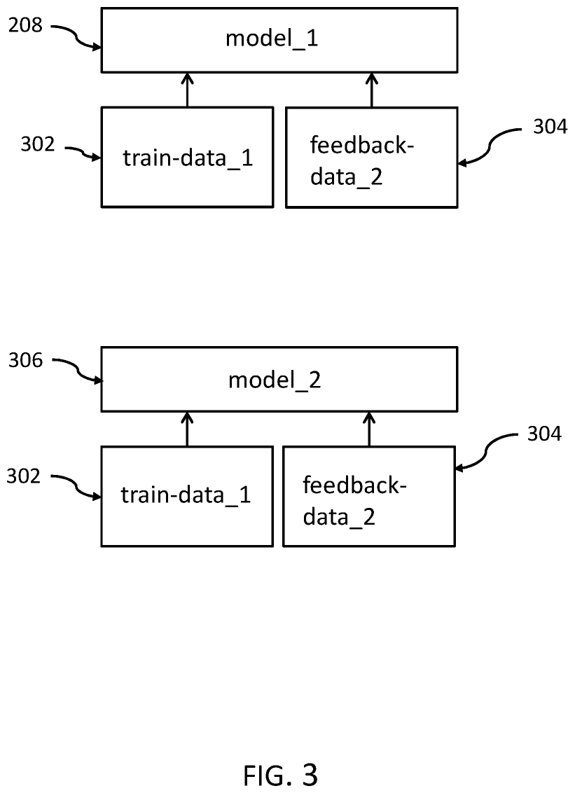

In a second iteration, shown as the two partial figures of FIG. 3, the complete set of train-data_1 302 is again blended with feedback data: namely feedback-data_2 304 (i.e., a new set of feedback data) for validating the ML model_1 208. Further embodiments derive a quality evaluation value from the blended data.

In order to develop the next ML model_2 306, embodiments of the present invention (e.g., through training system 400) utilize the train-data_1 302 as well as feedback-data_2 304 to build k folds for the next round of k-fold cross-validation. Thus, the data used for the retraining as well as for the validation and thus, the original training data set train-data_0 204, the feedback-data_1 302 and the feedback-data_2 304. From here on, subsequent retraining phases can use the same approach to build new data sets for another retraining by adding in new set of feedback-data_x to the already existing data pool, where x represents the number of the retraining phase, and where the data in the enriched data set may be used for the cross-validation process. In the aforementioned embodiments, no records are skipped as in the retraining to result in the first retrained ML model 1.

It becomes apparent that the model retraining and validation in the first iteration, as shown in FIG. 2, is different to the model retraining and validation in the second iteration, as shown in FIG. 3.

For completeness reasons, FIG. 4 depicts an embodiment of the training system 400 for improving a machine learning process. In various aspects of the present invention, training system 400 performs the steps and processes of method 100 and the data manipulation described in detail with regard to FIG. 2 and FIG. 3. The system comprises a receiving unit 402 adapted for receiving a trained original machine learning model including related parameters and a set of training data with which the machine learning model has been trained, and a determination unit 404 adapted for determining an original quality evaluation value for the trained original machine learning model using a first set of feedback data.

The determination unit 404 is also adapted for triggering a retraining process (performed by a retraining module 406) for the original machine learning model if the quality evaluation value is below a quality threshold value. Thereby, the retraining process comprises a first retraining phase for (i.e., in the sense of “resulting in”) a first machine learning model and a second retraining phase for (i.e., in the sense of “resulting in”) a second machine learning model. Additionally, the first retraining phase comprises using the original set of training data and the first set of feedback data for a first k-fold cross-validation of the trained original machine learning model, wherein from a first validation fold of the first k-fold cross-validation those records are skipped that originate from the set of training data.

Thereby, the second retraining phase comprises using the original set of training data, the first set of feedback data, and a second set of feedback data for a second k-fold cross-validation of the trained original machine learning model, wherein from a second validation fold of the second k-fold cross-validation all records are used.

According to one aspect of the present invention, a computer-implemented method for improving a machine learning process may be provided. The method may comprise receiving a trained original machine learning model including related parameters and a set of training data with which the machine learning model has been trained. Additionally, the method comprises determining an original quality evaluation value for the trained original machine learning model using a first set of feedback data and triggering a retraining process for the original machine learning model if the quality evaluation value is below a quality threshold value. The retraining process may comprise a first retraining phase for a first machine learning model and a second retraining phase for a second machine learning model. Thereby, the first retraining phase may comprise using the original set of training data and the first set of feedback data for a first k-fold cross-validation of the trained original machine learning model, wherein from a first validation fold—in particular from more than the first validation fold—of the first k-fold cross-validation those records are skipped that originate from the set of training data.

The second retraining phase may use the original set of training data, the first set of feedback data, and a second set of feedback data for a second k-fold cross-validation of the trained original machine learning model. Thereby from a second validation fold—in particular, from more than only the second validation fold—of the second k-fold cross-validation all records are used.

According to another aspect of the present invention, a training system for improving a machine learning process may be provided. The training system may comprise a receiving unit adapted for receiving a trained original machine learning model including related parameters and a set of training data with which the machine learning model has been trained. Additionally, the system may comprise a determination unit adapted for determining an original quality evaluation value for the trained original machine learning model using a first set of feedback data. The determination unit may also be adapted for triggering a retraining process for the original machine learning model if the quality evaluation value is below a quality threshold value. The retraining process may comprise a first retraining phase for a first machine learning model and a second retraining phase for a second machine learning model. Thereby, the first retraining phase may comprise using the original set of training data and the first set of feedback data for a first k-fold cross-validation of the trained original machine learning model, wherein from a first validation fold of the first k-fold cross-validation those records are skipped that originate from the set of training data.

The second retraining phase may comprise using the original set of training data, the first set of feedback data, and a second set of feedback data for a second k-fold cross-validation of the trained original machine learning model, wherein from a second validation fold of the second k-fold cross-validation all records are used.

The proposed computer-implemented method for improving a machine learning process may offer multiple advantages and technical effects. Embodiments of the present invention address a series of potential issues by treating the original training, the first retraining, and the second retraining equally. Firstly, the first retraining iteration does not include retraining cross-validation values for the initial machine learning (ML) model, so that a determination on whether a re-deployment of a new machine learning model should take place. Thus, the initial ML model and the retrained ML model after the first training phase are not comparable and thus, a determination on which model is “better” is not made (i.e., would deliver a better accuracy for new data).

Secondly, the validation value of the initial model, determined during a monitoring phase using feedback data may be determined on different data sets and using different a method than a metric value calculation during the retraining of a second model (i.e., training/testing split versus cross-validation). That may lead to an incorrect comparison between the accuracy results of the different models, and thus decisions about a redeployment of a better model may be inaccurate.

Thirdly, the accuracy evaluation value calculated during the retraining of the second model may be calculated on different data sets—in particular comprising feedback data—than the first, initial machine learning model. That would also lead to an incorrect comparison and determination whether the newer model may be better.

Hence, using the traditional approach, a direct comparison of the initial model and a retrained model, in comparison to two different retraining models, would be inaccurate and may lead to misleading recommendations for a retraining. Treating the first retraining phase differently than a second one and subsequent retraining phases may render the quality evaluation values comparable, so that decisions on whether to redeploy a retrained machine learning model or not, are based on the same criteria, and may thus be comparable.

Embodiments of the present invention recognize that if the original set up of the machine learning model and the initial training are done by a customer and the retraining phases are performed by a service provider for machine learning model services, then the service provider may be able to deliver an improved machine learning model retraining and decisions about a re-deployment.

According to one embodiment of the method, a third and subsequent retraining phase may be treated equally to the second retraining phase. Thus, the first retraining round may be treated differently if compared to the next retraining rounds. Hence, the consistency of the treatment of the different retraining phases is significantly enhanced. Further, the retraining may be done by a service provider for a customer that performed did the first, initial training and set-up of the machine learning model.

According to another embodiment of the method, the first retraining phase may also comprise building k folds of a mixture of the original set of training data and the first set of feedback data, such that in each of the k folds, at least one feedback record from the first set of feedback data is present. Further, retraining of the original machine learning model using the built k folds (i.e., by the retraining) generates a corresponding set of first machine learning models, each of which corresponds to another one of the k folds used as retraining data. Hence, a set of machine learning models with different sets of parameters may become available. The parameters may be stored for further usage.

According to an additional embodiment of the method, the first retraining phase may also comprise determining a set of first partial quality evaluation values, each value corresponding to one of the sets of first machine learning models. Thus, each of the machine learning models may be evaluated and may be compared to other machine learning models.

According to a further enhanced embodiment of the method, the first retraining phase may also comprise determining as first quality evaluation value an average value or mean value of the first partial quality evaluation values. This may represent a quality or accuracy of the whole first retraining effort.

According to another embodiment of the method, the second retraining phase may also comprise expanding the k folds by at least one record of a second set of feedback data and retraining each of the first set of machine learning models using the expanded set of k folds. Such embodiments can generate a corresponding set of second machine learning models, each of which corresponds to another one of the k folds used as retraining data. Accordingly, and also for subsequent retraining phases, skipping a record in the retraining of data sets is not necessary. Thus, subsequent retraining phases may be treated equally and no bias from differently treated retraining conditions may influence the results. Hence, the different ML model from the different training phases becomes comparable, not only from the second ML model onward, but from the first retraining phase.

According to a further embodiment of the method, the second retraining phase may also comprise determining a set of second partial quality evaluation values, each value corresponding to one of the set of second machine learning models. The process step can execute as mirroring the process regarding the first partial quality evaluation values. According to this embodiment of the method, the second retraining phase may also comprise determining, as second quality evaluation value, an average value (i.e., a mean value) of the second partial quality evaluation values, which can enable an easy comparison with the results of the first retraining.

According to one additional embodiment, the method may also comprise redeploying the second machine learning model as original machine learning model if the second quality evaluation value is better (e.g., in particular if the quality evaluation value is larger) than the first quality evaluation value (i.e., the prediction of unknown data would be better with a higher quality evaluation value).

Additionally, the model may be delivered back as a retrained machine learning model to the customer (e.g., the individual that initially provides the ML model).

In example embodiments, the machine learning model may be in the form of a multiclass classifier, a binary classifier, and a regression algorithm unit. Thus, the proposed concept may work with typical machine learning frameworks and algorithms.

According to another example embodiment of the method, the machine learning models may be neural networks. Thus, also for the class of machine learning environments, the proposed concept may be applicable. The same is true for the case in which the machine learning models may be convolutional neural networks. Various embodiments of the present invention allow for the proposed concept to execute with any machine learning model, framework, and set of algorithms.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain means for storing, communicating, propagating or transporting the program for use, by, or in connection, with the instruction execution system, apparatus, or device.

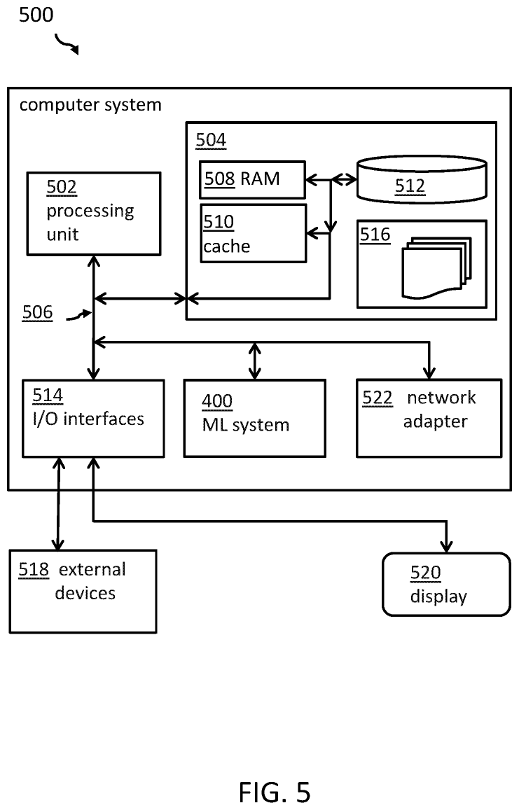

Embodiments of the invention may be implemented together with virtually any type of computer, regardless of the platform being suitable for storing and/or executing program code. FIG. 5 shows, as an example, a computing system 500 suitable for executing program code related to the proposed method.

The computing system 500 is only one example of a suitable computer system, and is not intended to suggest any limitation as to the scope of use or functionality of embodiments of the invention described herein, regardless, whether the computer system 500 is capable of being implemented and/or performing any of the functionality set forth hereinabove. In the computer system 500, there are components, which are operational with numerous other general purpose or special purpose computing system environments or configurations. Examples of well-known computing systems, environments, and/or configurations that may be suitable for use with computer system/server 500 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 500 may be described in the general context of computer system-executable instructions, such as program modules, being executed by a computer system 500. Generally, program modules may include routines, programs, objects, components, logic, data structures, and so on that perform particular tasks or implement particular abstract data types. Computer system/server 500 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computer system/server 500 is shown in the form of a general-purpose computing device. The components of computer system/server 500 may include, but are not limited to, one or more processors or processing units 502, a system memory 504, and a bus system 506 that couple various system components including system memory 504 to the processor 502. Bus system 506 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 500 typically includes a variety of computer system readable media. Such media may be any available media that is accessible by computer system/server 500, and it includes both, volatile and non-volatile media, removable and non-removable media.

The system memory 504 may include computer system readable media in the form of volatile memory, such as random access memory (RAM) 508 and/or cache memory 510. Computer system/server 500 may further include other removable/non-removable, volatile/non-volatile computer system storage media. By way of example only, a storage system 512 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus system 506 by one or more data media interfaces. As will be further depicted and described below, memory 504 may include at least one program product having a set (e.g., at least one) of program modules that are configured to carry out the functions of embodiments of the invention.

The program/utility, having a set (at least one) of program modules 516, may be stored in memory 504 by way of example, and not limiting, as well as an operating system, one or more application programs, other program modules, and program data. Each of the operating systems, one or more application programs, other program modules, and program data or some combination thereof, may include an implementation of a networking environment. Program modules 516 generally carry out the functions and/or methodologies of embodiments of the invention, as described herein.

The computer system/server 500 may also communicate with one or more external devices 518 such as a keyboard, a pointing device, a display 520, etc.; one or more devices that enable a user to interact with computer system/server 500; and/or any devices (e.g., network card, modem, etc.) that enable computer system/server 500 to communicate with one or more other computing devices. Such communication can occur via Input/Output (I/O) interfaces 514. Still yet, computer system/server 500 may communicate with one or more networks such as a local area network (LAN), a general wide area network (WAN), and/or a public network (e.g., the Internet) via network adapter 522. As depicted, network adapter 522 may communicate with the other components of the computer system/server 500 via bus system 506. It should be understood that, although not shown, other hardware and/or software components could be used in conjunction with computer system/server 500. Examples, include, but are not limited to: microcode, device drivers, redundant processing units, external disk drive arrays, RAID systems, tape drives, and data archival storage systems, etc.

Additionally, the training system 400 for improving a machine learning process may be attached to the bus system 506.

The descriptions of the various embodiments of the present invention have been presented for purposes of illustration but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer readable storage medium (or media) having computer readable program instructions thereon for causing a processor to carry out aspects of the present invention.

The medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the invention. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

What is claimed is:

1. A computer-implemented method for machine learning model training, the method comprising
receiving, by one or more processors, a trained original machine learning model, including related parameters and a set of training data with which the trained original machine learning model has been trained;
determining, by one or more processors, an original quality evaluation value for the trained original machine learning model using a first set of feedback data; and
in response to determining that the quality evaluation value is below a quality threshold value, triggering, by one or more processors, a retraining process for the original machine learning model, the retraining process comprising a first retraining phase for a first machine learning model and a second retraining phase for a second machine learning model.

2. The method of claim 1, wherein the first retraining phase further comprises:
performing, by one or more processors, a first k-fold cross-validation of the trained original machine learning model using the original set of training data and the first set of feedback data, wherein, from a first validation fold of the first k-fold cross-validation, skipping records that originate from said set of training data.

3. The method of claim 2, wherein the second retraining phase further comprises:
performing, by one or more processors, a second k-fold cross-validation of said trained original machine learning model using the original set of training data, the first set of feedback data, and a second set of feedback data, wherein the second k-fold cross-validation utilizes all records from a second validation fold.

4. The method according to claim 3, wherein a third retraining phase and subsequent retraining phases are treated equally to the second retraining phase.

5. The method according to claim 2, wherein the first retraining phase further comprises:
building, by one or more processors, k folds of a mixture of the original set of training data and the first set of feedback data such that, in each of the k folds, at least one feedback record from the first set of feedback data is present; and
retraining, by one or more processors, the original machine learning model using the built k folds thereby generating a corresponding set of first machine learning models, wherein the corresponding set of first machine learning models corresponds to another one of the k folds used as retraining data.

6. The method according to claim 5, wherein the first retraining phase further comprises:
determining, by one or more processors, a set of first partial quality evaluation values, wherein each instance within the set of first partial quality evaluation values corresponds to a respective instance within the set of first machine learning models.

7. The method according to claim 6, wherein the first retraining phase further comprises:
determining, by one or more processors, a first quality evaluation value as an average value of the first partial quality evaluation values.

8. The method according to claim 5, wherein the second retraining phase further comprises:
expanding, by one or more processors, the k folds by at least one record of a second set of feedback data; and
retraining, by one or more processors, each of the first set of machine learning models using the expanded set of k folds, thereby generating a corresponding set of second machine learning models each of which corresponds to another one of the k folds used as retraining data.

9. The method according to claim 8, wherein the second retraining phase further comprises:
determining, by one or more processors, a set of second partial quality evaluation values, each instance within the set of second partial quality evaluation values corresponds to a respective instance within the set of second machine learning models; and
determining, by one or more processors, a second quality evaluation value as an average value of the second partial quality evaluation values.

10. The method according to claim 9, further comprising:
in response to determining that the second quality evaluation value is better than said first quality evaluation value, redeploying, by one or more processors, the second machine learning model in place of the original machine learning model.

11. The method according to claim 1, wherein said machine learning models are selected from the group consisting of: a multiclass classifier, a binary classifier, and a regression algorithm unit.

12. The method according to claim 1, wherein said machine learning models are neural networks.

13. The method according to claim 1, wherein said machine learning models are convolutional neural networks.

14. A computer program product for machine learning model training, the computer program product comprising:
one or more computer readable storage media and program instructions stored on the one or more computer readable storage media, the program instructions comprising:
program instructions to receive a trained original machine learning model, including related parameters and a set of training data with which the trained original machine learning model has been trained;
program instructions to determine an original quality evaluation value for the trained original machine learning model using a first set of feedback data; and
in response to determining that the quality evaluation value is below a quality threshold value, program instructions to trigger a retraining process for the original machine learning model, the retraining process comprising a first retraining phase for a first machine learning model and a second retraining phase for a second machine learning model.

15. The computer program product of claim 14, further comprising program instructions, stored on the one or more computer readable storage media, to:
perform a first k-fold cross-validation of the trained original machine learning model using the original set of training data and the first set of feedback data, wherein, from a first validation fold of the first k-fold cross-validation, skipping records that originate from said set of training data.

16. The computer program product of claim 15, further comprising program instructions, stored on the one or more computer readable storage media, to:
perform a second k-fold cross-validation of said trained original machine learning model using the original set of training data, the first set of feedback data, and a second set of feedback data, wherein the second k-fold cross-validation utilizes all records from a second validation fold.

17. A computer system for machine learning model training, the computer system comprising:
one or more computer processors;
one or more computer readable storage media; and
program instructions stored on the computer readable storage media for execution by at least one of the one or more processors, the program instructions comprising:
program instructions to receive a trained original machine learning model, including related parameters and a set of training data with which the trained original machine learning model has been trained;
program instructions to determine an original quality evaluation value for the trained original machine learning model using a first set of feedback data; and
in response to determining that the quality evaluation value is below a quality threshold value, program instructions to trigger a retraining process for the original machine learning model, the retraining process comprising a first retraining phase for a first machine learning model and a second retraining phase for a second machine learning model.

18. The computer system of claim 17, further comprising program instructions, stored on the computer readable storage media for execution by at least one of the one or more processors, to:
perform a first k-fold cross-validation of the trained original machine learning model using the original set of training data and the first set of feedback data, wherein, from a first validation fold of the first k-fold cross-validation, skipping records that originate from said set of training data.

19. The computer system of claim 18, further comprising program instructions, stored on the computer readable storage media for execution by at least one of the one or more processors, to:
perform a second k-fold cross-validation of said trained original machine learning model using the original set of training data, the first set of feedback data, and a second set of feedback data, wherein the second k-fold cross-validation utilizes all records from a second validation fold.

20. The computer system of claim 17, wherein said machine learning models are neural networks.
